(19) United States
(12) Patent Application Publication
(10) Pub. No.: US 2019/0007554 A1
(43) Pub. Date: Jan. 3, 2019

(54) CLOUD-BASED PHONE POP-UP SYSTEM

(71) Applicant: Celervox, LLC, Highland, UT (US)

(72) Inventor: Joe Strom, Highland, UT (US)

(21) Appl. No.: 16/022,365

(22) Filed: Jun. 28, 2018

Related U.S. Application Data
(60) Provisional application No. 62/527,837, filed on Jun. 30, 2017.

(51) Int. Cl. H04M 3/51; H04L 29/08; G06F 17/30

(52) U.S. Cl. CPC H04M 3/5191; G06F 17/30867; H04L 67/306; H04M 3/5166

(57) ABSTRACT

A computer system for automatically providing database information to a receiver computer based upon an attribute of an incoming communication receives an incoming communication from a first input selected from a set of inputs. The computer system identifies a protocol associate with the incoming communication. The computer system then causes a graphical element on a computer system to be displayed. Additionally, the computer system parses a communication identifier from the incoming communication. The computer system then transmits the communication identifier to a remote database server. In response, the computer system receives from the remote database server a caller ID identification that is associated with the communication identifier, and at least one client-specific communication prompt. Further, the computer system displays, within the graphical element, the client identification and the at least one client-specific communication prompt.

This application claims the benefit of and priority to U.S. Provisional Patent Application Ser. No. 62/527,837 filed on Jun. 30, 2017, and entitled “CLOUD-BASED PHONE POP-UP SYSTEM,” which application is incorporated herein by reference in its entirety.

### BACKGROUND

Despite the vast disruption caused by computers and internet technology within the business and customer-service industries, many people still prefer to talk with an actual person when dealing with customer service issues. This is particularly the case when the call involves trouble-shooting or other quality assurance issues. While human customer service representatives are able to provide a much more personalized conversation experience, in many cases they are lacking contextual information about the clients who are calling in.

It is desirable for a customer-service representative to have access to background information about a customer as soon as the client calls in. Various systems have been proposed and are used to provide this service. However, conventional systems of this type tend to be cumbersome and often require significant investment into entirely new phone systems and infrastructure. There is a need for an adaptable system that can be easily adapted to many different conventional phone systems.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

In at least one disclosed embodiment, a computer system automatically provides database information to a receiver computer based upon an attribute of an incoming communication. For example, the computer system receives an incoming communication from a first input selected from a set of inputs. The computer system identifies a protocol associated with the incoming communication. The computer system then causes a graphical element on a computer system to be displayed. Additionally, the computer system parses a communication identifier from the incoming communication. The computer system then transmits the communication identifier to a remote database server. In response, the computer system receives from the remote database server a caller ID identification that is associated with the communication identifier and at least one client-specific communication prompt. Further, the computer system displays, within the graphical element, the client identification and the at least one client-specific communication prompt.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates a schematic of a component of an embodiment of a call handling device.

FIG. 2 illustrates a component in an embodiment of a call handling device.

FIG. 3 illustrates another component in an embodiment of a call handling device.

FIG. 4 illustrates an image of an assembled embodiment of a call handling device.

FIG. 5 illustrates an embodiment of a graphical element.

FIG. 6 illustrates a flow chart of steps in an embodiment of a method for handling communications.

### DETAILED DESCRIPTION

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

Disclosed embodiments include systems, devices, and methods for dynamically handling different types of calls through a centralized customer information database. For example, disclosed embodiments are able to dynamically handle both session initiation protocol (“SIP”) phone calls and plain old telephone service (“POTS”) phone calls. At least one embodiment of a disclosed call handling device comprises one or more interfaces for an RJ11 connector and one or more interfaces for connecting to the internet. As such, phone calls can be received through either interface.

A user may operate with a single call handling device or multiple call handling devices. In any case, each call handling device is located on premise. Typically, a call handling device would be located next to a telephone and a computer. Because the call handling device is located locally, the call handling device is behind the user's firewall. Placing the call handling device behind the user's firewall provides a significant benefit when trying to establish network connections between the call handling device and a centralized customer information database.

In at least one embodiment, the call handling device intercepts a call. The call can be intercepted using POTS protocol, SIP protocol, or any other applicable phone communication protocol. The call handling device gathers call details (e.g., caller ID) and transmits the call details to a remote server. In at least one embodiment, the transmitted information includes a user identification, caller ID information from the intercepted phone call, and an identifier of the user's phone number that the phone call was intercepted on.

The remote server is in communication with the centralized customer information database. The remote server accesses the centralized customer information database and identifies an entry that corresponds with the caller ID information that was sent by the call handling device. Based upon information within the entry and user-specific settings stored at the remote server, the remote server generates a specific type of return communication that the remote server communicates to a user computer system that is associated with the calling handling device.

In at least one embodiment, the call handling device comprises two POTS lines and unlimited SIP lines to be monitored for call activity. The call handling device unifies the details available from each type of call and uses HTTP REST to PUT those call events to the remote server. In at least one embodiment, the call handling device uses a pair of HT9032D chips and the related circuitry combined into a custom circuit board. The custom circuit board provides an RJ11 jack for the office to plug-in two separate POTS phone lines (over a single jack).

In at least one embodiment, the custom circuit board is attached to a processing unit. For example, the circuit board may be attached to an ORANGE PI ZERO provided by ORANGE PI located at Room 201, 218-223, Area 2, Block B, Shenzhen-Mingyou Purchansing Certer, Baoyuan Road, Xixiang Street, Bao'an, Shenzhen, Guangdong, China. The output pins on the HT9032D chip tie into the GPIO pins of the ORANGE PI ZERO where the ORANGE PI ZERO then interprets the output and PUT results to the processing device. The processing device may comprise a network connection, such as an Ethernet port or Wi-Fi antenna, to connect to the user's network. The processing unit uses the network connection to PUT the call information to the remote server.

In at least one embodiment, the processing unit provides the call handling device with the networking and computational power need to function as a User Agent Client (UAC) within a SIP call. For example, the processing unit is configured to REGISTER with the same SIP server that the user's phone sends its REGISTER messages. One of skill in the art will appreciate that SIP servers allow for multiple devices to be associated to a single SIP address. Each of those devices sends its own REGISTER message and each REGISTER contains a unique “Contact” header. The result of this multi-registration is that the user's phone and the call handling device each get SIP INVITE messages for each call that comes into that office location.

In at least one embodiment, the call handling devices, despite receiving the INVITE messages, never responds with an OK to answer the phone call. Instead, the call handling device just lets the call continue to ring. Accordingly, the call handing device is capable of getting CallerID info concurrently with the user's phone. In at least one embodiment, the call handling device also employs SIP SUBSCRIBE, NOTIFY, and PUBLISH methods. In at least one embodiment, the call handling device uses all three methods described above at the same time and abstracts the differences so that it can operate with a single API at the remote server.

In at least one embodiment, prior to sending the call information to the remote server, the call handling device causes a graphical element, such as a window, to popup on the user's computer screen. The call handling device then sends the call information to the remote server. The remote server accesses the centralized customer information database and identifies information associated with the Caller ID that was sent in the call information. Based upon the accessed information within the centralized customer information database and user-specific information stored at the remote server, the remote server generates information that is sent to the user's computer. The user then displays at least a portion of the information in the graphical element.

In at least one embodiment, the user's computer executes a call handling software application. Further, in at least one embodiment, the call handling software application has two components. The first component comprises a native application component that is executed on the user's computer. The second component comprises a remote software component that is executed on the remote server. The remote software component feeds content to an embedded browser within the native application component.

In at least one embodiment, the call handling software is tightly integrated with the call handling device—despite the call handling software executing on a separate device than the call handling device. When the call handling device receives a phone call, it immediately sends a data packet to an API within the call handling software. The data packet comprises a phone number representing a caller. In response to receiving the data packet, the call handling software application causes an instance of a screen (i.e., a graphical element) that is hidden in the system tray to be made visible.

The call handling device then passes the received phone number as part of a query string to a default url/script on the remote server. The remote server performs a lookup in the centralized customer information database. If a corresponding entry is found, the remote server communicates customer information to the call handing software application at the user's computer. In response to receiving the customer information, the call handling software loads a customer home page screen with the pertinent data about the customer into the graphical element.

In contrast, if the phone number is not found, a default screen representing a potential customer is displayed. The remote software component is integrated with 3rd party Customer Relations Management Software (CRMs) or Property Management Software (PMS) representing each company's pertinent data for doing business with their customers. These integrations require data access into the CRM/PMS via APIs, and data used in a screen pop instantiation can either be done via direct API calls into the CRM/PMS (when performance allows so) or querying previously download data from the remote server's database associated with that account.

Within a graphical element displayed on the user's computer, a client can view alerts, record notes, view appointment info, review call and SMS logs, view account details, email or text customer, make appointments, etc. On non-customer specific screens, a user can search and browse customers, view appointment schedules, create and review reminders, see daily log history for company account, view relevant call and customer analytics, etc.

In at least one embodiment, a user activates a call handling device by calling into a specific phone number that comes with the call handling device at the time of purchase. For example, at the time of purchase, a user is provided with a set-up number. Upon calling the set-up number the user provides a phone number that the call handling device is to be associated with.

A computer associated with the specific phone number then calls the number provided by the user from a phone number that is associated with an arbitrary, fake caller ID. Upon receiving the phone call, the call handling device automatically sends the arbitrary, fake caller ID to the remote server. Upon identifying the arbitrary, fake caller ID, the remote server is able to properly associate the call handling device with the correct user.

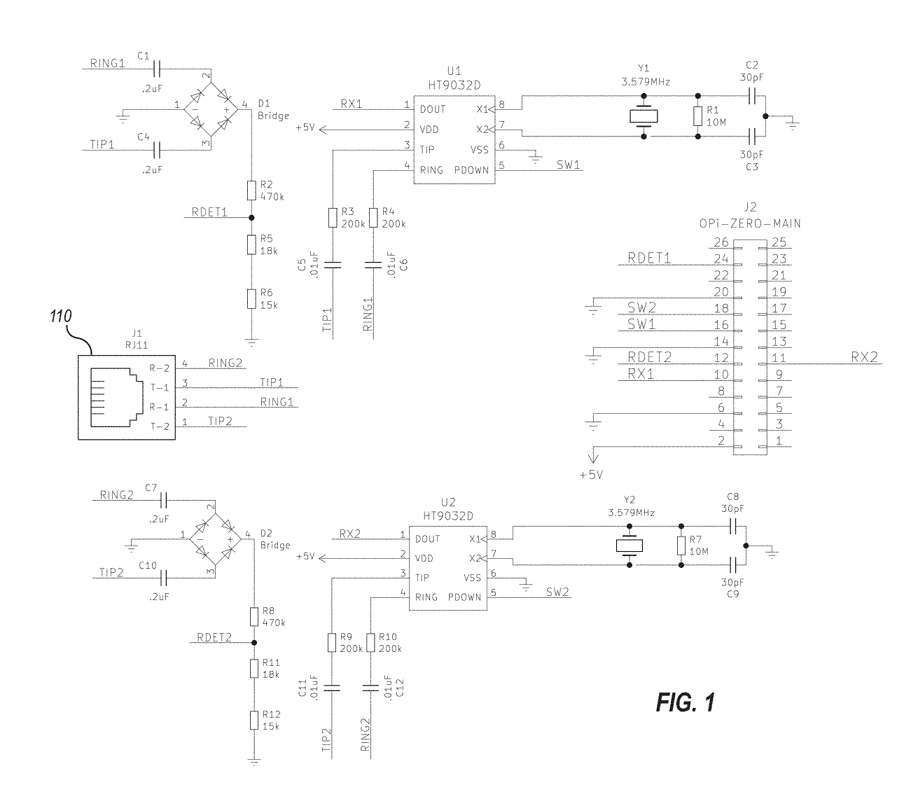

FIG. 1 illustrates a schematic of a custom circuit board 100 within an embodiment of a call handling device. In particular, the schematic depicts the custom circuit board 100 disclosed above. The custom circuit board 100 comprises at least one RJ11 connector 110 for receiving a phone line. The custom circuit board 100 also comprises a processing chip for performing various programmed functions disclosed herein.

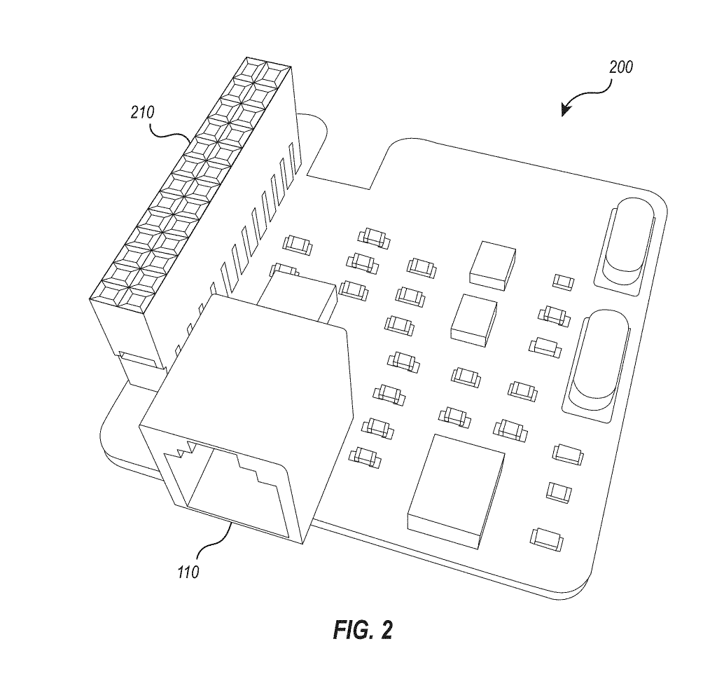

FIG. 2 illustrates an image of the first processing component 200 in an embodiment of a call handling device. The depicted first processing component 200 comprises an RJ11 connector 110 and a female pin connector 210. In at least one embodiment, the first processing component 200 comprises the components necessary to handle incoming POTS calls. For example, the first processing component 200 may comprise computer chips that are able to extract caller ID information from an incoming phone call.

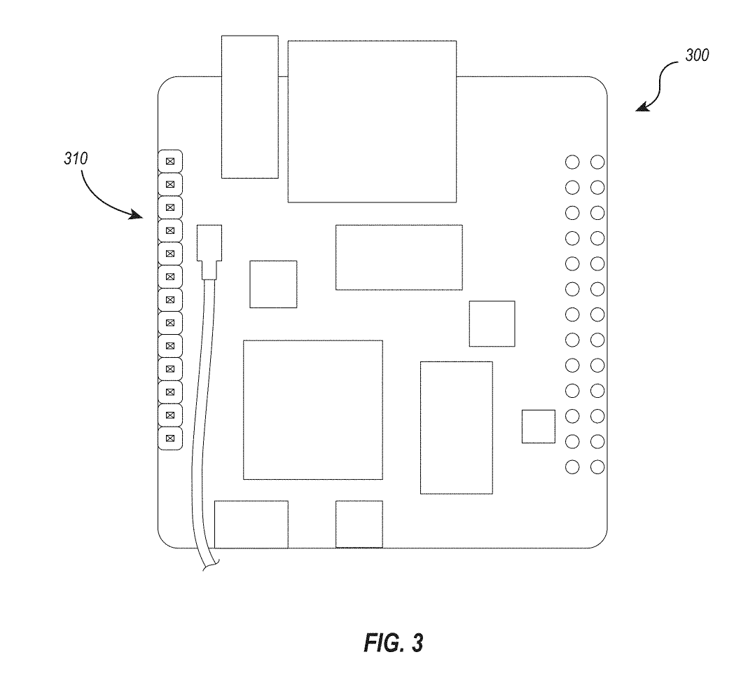

FIG. 3 illustrates an image of a second processing component 300 in an embodiment of a call handling device. The depicted second processing component 300 comprises an ORANGE PI ZERO. In at least one embodiment, the second processing component 300 connects to the first processing component 200 through male pin connectors 310. The second processing component 300 may be configured with the components necessary to receive SIP phone calls. For example, the second processing component 300 is capable of gathering caller ID information from a SIP phone call.

Additionally, in at least one embodiment, the second processing component 300 is also configured to connect to a network. The second processing component 300 is further configured to communicate call information to a remote server. As explained above, the remote server accesses the centralized customer information database to gather information of interest.

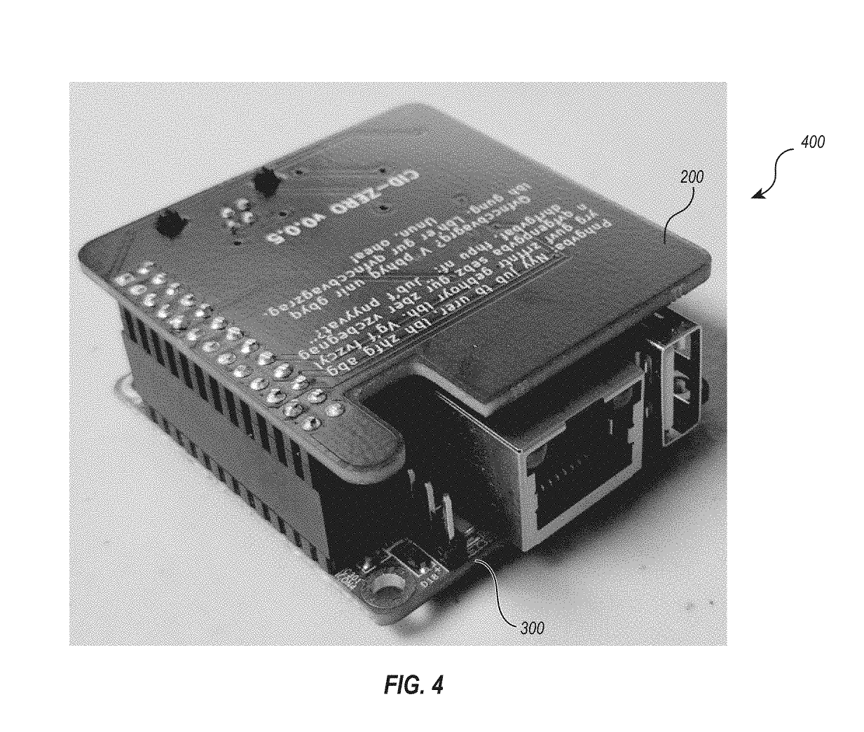

FIG. 4 illustrates an image of an assembled embodiment of a call handling device 400. In particular, the first processing component 200 has been attached to the second processing component 300. In such a configuration, calls received by the call handling device 400 are passed to the second processing component 300 for further processing and communication to the cloud.

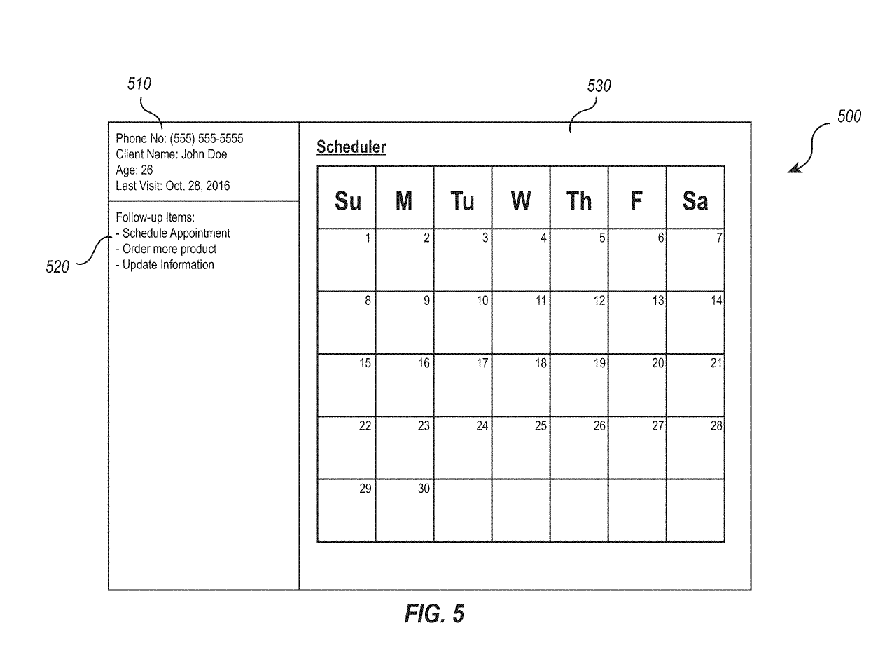

FIG. 5 depicts an embodiment of a graphical element 500 that displays in response to the call handling device 400 receiving an incoming communication. The call handling device 400 and/or the remote server (not shown) may cause a computer associated with the call handling device 400 to display the graphical element 500. The depicted embodiment of a graphical element 500 comprises caller information 510, communication prompts 520, and a scheduler 530.

The caller information 510 may comprise the caller's name, phone number, age, gender, and the previous reason for the client's phone call. One will appreciate, however, that this information is merely provided as an example and that different information can be displayed in other embodiments. The displayed information may be retrieved from the remote server and/or from a CRM or PMS.

The communication prompts 520 provide prompts for a user to follow when conversing with a client. For example, the communication prompts in FIG. 5 prompt the user to inquire about scheduling an appointment, ordering more product, or updating the client's information. These prompts may be intelligently generated. For example, the remote server may determine that this client is a dental patient that the client's 6-month check-up is approaching. Based upon this determination, the remote server may send a communication prompt to inquire about setting up a new appointment.

The graphical element 500 may also provide resources for scheduling an appointment 530. The example of a scheduler 530 is only provided for the sake of discussion. One will appreciate that any number of different resources could be provided to an end user. For example, the remote server may determine a set of likely prompts 520. The display resource may match the selected prompts. For instance, the remote server may determine that the client is likely calling to order a product. Based upon this determination, point-of-sale system may be presented in order to process the client's potential order.

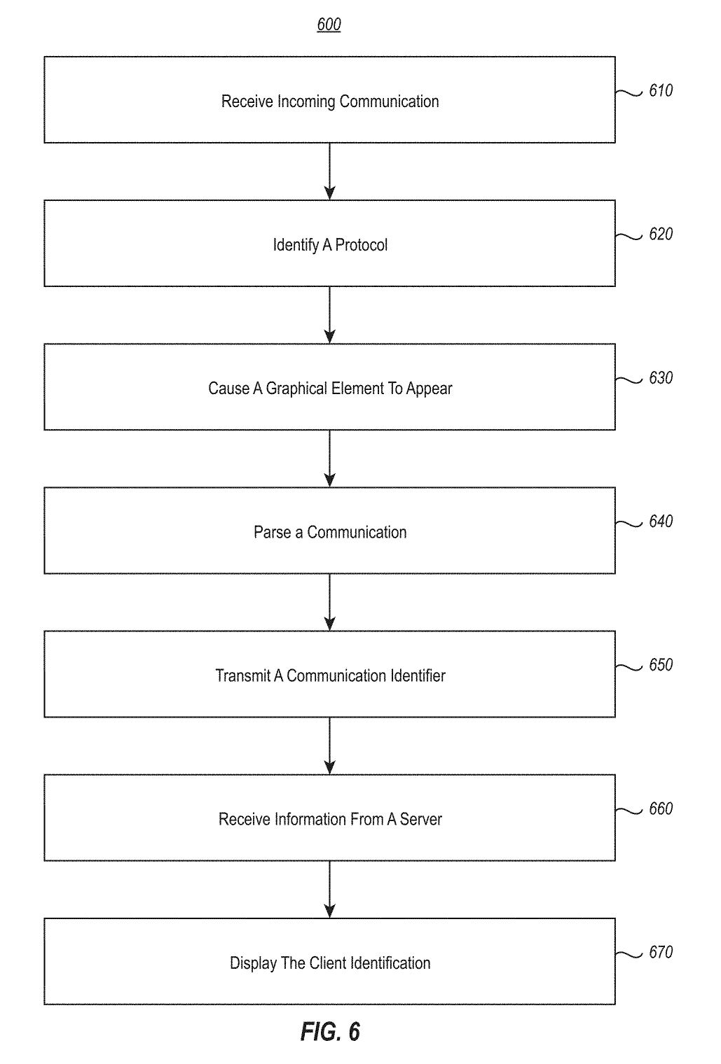

FIG. 6 illustrates a flow chart of steps in an embodiment of a method 600 for handling communications. The method 600 comprises an act 610 of receiving an incoming communication from a first input selected from a set of inputs. The method 600 also comprises an act 620 of identifying a protocol associated with the incoming communication. Additionally, the method 600 includes an act 630 of causing a graphical element on a computer system to be displayed. The method 600 then includes an act 640 of parsing a communication identifier from the incoming communication. The method 600 subsequently includes an act 650 of transmitting the communication identifier to a remote database server. Further, the method 600 includes an act 660 of receiving from the remote database server a caller ID identification that is associated with the communication identifier, and at least one client-specific communication prompt. Further still, the method 600 includes displaying, within the graphical element, the client identification and the at least one client-specific communication prompt.

Accordingly, a call handling device 400 is disclosed that is capable of receiving both SIP and POTS calls without requiring special built telephone networks. Further, a disclosed call handling device 400 is capable of querying a remote database in response to either a POTS or a SIP phone call and, based upon the caller ID, gathering information relating to the incoming caller. Further, a disclosed call handling device is capable of causing a graphical element (i.e., a pop-up window) to appear on an associated computer.

Further, the methods may be practiced by a computer system including one or more processors and computer-readable media such as computer memory. In particular, the computer memory may store computer-executable instructions that when executed by one or more processors cause various functions to be performed, such as the acts recited in the embodiments.

Computing system functionality can be enhanced by a computing systems' ability to be interconnected to other computing systems via network connections. Network connections may include, but are not limited to, connections via wired or wireless Ethernet, cellular connections, or even computer to computer connections through serial, parallel, USB, or other connections. The connections allow a computing system to access services at other computing systems and to quickly and efficiently receive application data from other computing systems.

Interconnection of computing systems has facilitated distributed computing systems, such as so-called “cloud” computing systems. In this description, “cloud computing” may be systems or resources for enabling ubiquitous, convenient, on-demand network access to a shared pool of configurable computing resources (e.g., networks, servers, storage, applications, services, etc.) that can be provisioned and released with reduced management effort or service provider interaction. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

Cloud and remote based service applications are prevalent. Such applications are hosted on public and private remote systems such as clouds and usually offer a set of web-based services for communicating back and forth with clients.

Many computers are intended to be used by direct user interaction with the computer. As such, computers have input hardware and software user interfaces to facilitate user interaction. For example, a modern general-purpose computer may include a keyboard, mouse, touchpad, camera, etc. for allowing a user to input data into the computer. In addition, various software user interfaces may be available.

Examples of software user interfaces include graphical user interfaces, text command line-based user interface, function key or hot key user interfaces, and the like.

Disclosed embodiments may comprise or utilize a special purpose or general-purpose computer including computer hardware, as discussed in greater detail below. Disclosed embodiments also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer-readable storage media and transmission computer-readable media.

Physical computer-readable storage media includes RAM, ROM, EEPROM, CD-ROM or other optical disk storage (such as CDs, DVDs, etc.), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry program code in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RANI and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general-purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer system for automatically providing database information to a receiver computer based upon an attribute of an incoming communication comprising:
one or more processors; and
one or more computer-readable media having stored thereon executable instructions that when executed by the one or more processors configure the computer system to perform at least the following:
receive an incoming communication from a first input selected from a set of inputs;
identify a protocol associated with the incoming communication;
cause a graphical element on a computer system to be displayed;
parse a communication identifier from the incoming communication;
transmit the communication identifier to a remote database server;
receive from the remote database server:
a caller ID identification that is associated with the communication identifier, and
at least one client-specific communication prompt; and
display, within the graphical element, the client identification and the at least one client-specific communication prompt.
